(19) United States
(12) Patent Application Publication
(10) Pub. No.: US 2025/0084964 A1
(43) Pub. Date: Mar. 13, 2025

(54) FILLING DEVICE FOR HYDROGEN TANKS, HYDROGEN TANK HAVING THE FILLING DEVICE, AND METHOD FOR FILLING A HYDROGEN TANK

(71) Applicant: ARGO GMBH, Wesel (DE)

(72) Inventor: Jan ANDREAS, Wesel (DE)

(21) Appl. No.: 18/580,538

(22) PCT Filed: Jul. 18, 2022
(86) PCT No.: PCT/EP2022/070023

§ 371 Date: Jan. 18, 2024

(30) Foreign Application Priority Data
Jul. 20, 2021 (DE) 10 2021 207 716.1

(51) Int. Cl. F17C 13/04

(52) U.S. Cl. CPC F17C 13/04; F17C 2205/0323; F17C 2205/0332; F17C 2221/012; F17C 2227/0114; F17C 2250/043; F17C 2250/0439; F17C 2265/065

(57) ABSTRACT

Disclosed herein is a filling device for filling a storage tank with compressed hydrogen. Also disclosed are storage tanks including the filling device, as well as methods for filling a hydrogen tank with compressed hydrogen.

### TECHNICAL FIELD

The present invention relates to a filling device for hydrogen tanks, which serves to fill hydrogen tanks with hydrogen, in particular compressed gaseous and/or vaporous hydrogen, a hydrogen tank (high-pressure storage) comprising the filling device according to the invention as well as a method for filling a hydrogen tank, in particular by using the filling device according to the invention.

### PRIOR ART

Recently, more and more vehicle manufacturers have been presenting motor vehicles powered by gaseous fuels such as natural gas, LPG or hydrogen. These include not only passenger cars, but also buses, trucks and forklifts. Parallel to the growing number of vehicles operated with compressed gases, the number of refueling stations is also growing, especially the number of hydrogen refueling stations. The hydrogen refueling stations are more often used by private customers. Owing to the higher pressures and significantly lower temperatures of the hydrogen compared to natural gas or LPG, new developments for refueling methods and other devices are necessary in particular for refueling with hydrogen. In addition, the costs for providing the hydrogen must be kept as low as possible in order to increase acceptance compared to other fuels. At the same time, the necessary refueling process with hydrogen is supposed to be simplified, its safety increased and, at the same time, the necessary time shortened.

Hydrogen refueling stations already exist where refueling of a vehicle with gaseous hydrogen can be carried out with pressures of up to 700 bar. In order to be able to refuel several vehicles successively and/or simultaneously, refueling methods are usually used in which large amounts of pressurized gaseous hydrogen are temporarily stored in corresponding pressure buffers (up to 900 bar).

During high-pressure filling of hydrogen tanks, the hydrogen is heated. Moreover, a temperature gradient builds up inside the tank since the cold, injected hydrogen flows into the lower area of the tank due to its higher density, while hotter layers are forced upwards. However, the tank shell (especially the plastic liner) must not be heated too much in this process. In order to avoid local temperature peaks in the hydrogen tank or that too high a temperature is generally reached during the filling process, both of which can be dangerous to the integrity of the hydrogen tank, the filling speed is limited, which is contrary to the desire for shorter refueling processes. Furthermore, it is necessary to cool the hydrogen to low temperatures of down to −40° C. before the refueling process to prevent the hydrogen from heating up to a critical temperature during the filling process.

Therefore, there is a great demand for filling devices or filling methods which, on the one hand, avoid the temperature increase inside the hydrogen tank during refueling, in particular the occurrence of temperature peaks, and, on the other hand, offer the possibility of faster filling or higher flow rates of hydrogen during refueling.

### DESCRIPTION OF THE INVENTION

Against the background of the above-stated demand, it is an object of the present invention to provide a filling device for hydrogen tanks, a hydrogen tank comprising a filling device according to the invention as well as a method for filling hydrogen tanks with hydrogen, which are able, on the one hand, to avoid the formation of a temperature gradient inside the hydrogen tank during filling and, on the other hand, to offer the possibility of faster filling at higher flow rates/influx rates of hydrogen during refueling, or to reduce the above-described power-consuming cooling of the hydrogen prior to the filling process to temperatures of down to −40° C. to a value that is less cold (for example, −25° C.), without having to reduce the refueling speed.

The stated object is solved by a filling device for filling hydrogen tanks with hydrogen according to claim 1, a storage tank or hydrogen tank according to claim 14 as well as a method for filling a hydrogen tank according to claim 15. Preferred further developments of the invention are given in the dependent claims.

In this regard, one of the basic ideas of the present invention is to provide a main body and/or a tube with at least one opening configured to cause a suction effect on the hydrogen already present in the storage tank when the hydrogen flows into the storage tank through the main body and the tube into the storage tank or hydrogen tank.

In this way, the hydrogen already present in the storage tank and/or the hydrogen newly filled thereinto can be set into a circulating motion or flow, whereby the hydrogen introduced or fed into the storage tank can be better mixed, and thus a temperature gradient inside the hydrogen tank during filling can be avoided, whereby temperature peaks can be prevented, while the possibility of faster filling at higher flow rates/influx rates of hydrogen (grams per second) during refueling can be realized, or the same refueling speed can be achieved with less cold pre-cooling temperatures.

According to one aspect of the present invention, a filling device for filling a storage tank (hydrogen tank), in particular a storage tank of a vehicle, with compressed gaseous and/or vaporous hydrogen has: a main body, in particular a valve body, a tube, in particular an injector tube, which is configured, in a state when inserted into a storage tank, to extend preferably in an approximately axial direction of the storage tank and to introduce hydrogen into the storage tank, an ejection nozzle which is provided at one end of the tube that preferably protrudes into the storage tank and which serves to eject the hydrogen into the storage tank, and at least one opening which is introduced into the main body and/or the tube and is configured to cause a suction effect or negative pressure on the hydrogen already present in or newly introduced (shortly before) into the storage tank when the hydrogen flows into the storage tank.

As already mentioned above, it is thus made possible to set the hydrogen already present in the storage tank and/or the hydrogen newly introduced (shortly before) into the storage tank into a circulating motion, in particular from the ejection nozzle towards the opening, whereby it can be prevented that a temperature gradient is formed in the stored hydrogen, which can lead to undesired temperature peaks. In this way, it is made possible to increase the refueling flow rate from 60 grams/second, as is the standard today for passenger cars, to 120 grams/second or even 180 grams/second, without having to further cool down the hydrogen prior to refueling or filling (for example, it can be sufficient to cool the hydrogen to temperatures less cold than −40° C., e.g. −25° C.).

In the context of the present invention, the terms “vehicle” or “means of transport” or other similar terms as used below comprise motor vehicles in general, such as passenger automobiles including sports utility vehicles (SUVs), buses, trucks, various commercial vehicles, water vehicles including various boats and ships, aircraft, trains and the like, hybrid vehicles, electric vehicles, plug-in hybrid electric vehicles, hydrogen vehicles and other alternative vehicles (e.g. fuels gained from resources other than petroleum). As stated herein, hybrid vehicles are vehicles having two or more energy carriers, e.g. gasoline-powered and simultaneously electrically powered vehicles.

In this regard, it can be advantageous that the opening or recess is configured in the form of a round bore, an oval bore, an elongated slot or the like.

According to an embodiment of the present invention, it can be advantageous that the opening is connected with a flow channel in a flow-conducting manner in order to exert a Venturi effect on the opening or recess when the hydrogen flows through the tube into the storage tank.

According to a further embodiment of the present invention, it can be advantageous that the opening is configured in such a way that a circulation of the hydrogen introduced into the storage tank or the hydrogen already present therein can be generated from the ejection nozzle to the opening, wherein the opening extends or is aligned preferably in the axial direction (longitudinal direction) of the storage tank in a direction opposite to the ejection nozzle, in particular an opening direction of the ejection nozzle, preferably towards the head surface or head part of the storage tank, in which the connecting piece is provided.

Furthermore, it is advantageous if the filling device is configured as an injector that is preferably integrated into a valve, in particular an on-tank valve (OTV), which is configured to be attached to or mounted on the storage tank.

According to a further embodiment of the present invention, the device can comprise a connecting piece configured in such a way that it can be inserted or screwed into the storage tank, in particular a connecting piece of the storage tank.

Moreover, it is advantageous if the tube further comprises: a first curved section located between the ejection nozzle and the main body and extending in a direction that is inclined relative to the axial direction (longitudinal direction) of the storage tank, and a second curved section preferably comprising the ejection nozzle and extending in a direction that is inclined relative to the axial direction (longitudinal direction) of the storage tank.

According to a further embodiment, one of an inclination angle of the first curved section relative to the axial direction of the storage tank and an inclination angle of the second curved section relative to the axial direction of the storage tank can be greater than 0 degrees and not greater than 90 degrees and the other one can preferably be not smaller than −90 degrees and smaller than 0 degrees when the tube is viewed in a direction perpendicular to the axial direction of the storage tank.

Furthermore, it is preferred that a connecting section is provided between the first curved section and the second curved section, which extends preferably parallel to the axial direction of the storage tank, so that the tube extends in the axial direction towards the inside of the storage tank, in particular away from the main body.

In this way, the tube is bent at least twice in directions that are inclined relative to the axial direction of the storage tank, wherein the tube assumes an essentially U-shaped configuration between the first curved section and the second curved section, and thus the rigidity of the tube is increased.

Furthermore, it is advantageous if the filling device comprises a temperature detection device, in particular a temperature sensor, which extends from the main body in the axial direction of the storage tank towards the inside of the storage tank, wherein a temperature measuring portion of the temperature detection device is located between the ejection nozzle and the main body, in particular between the two curved sections.

According to a further embodiment of the present invention, it is advantageous if a flow channel formed by the opening, which connects the opening with the flow channel formed in the tube and/or the main body in a flow-conducting manner, forms an inclination angle relative to the axial direction of the storage tank in a range from 15 degrees to 45 degrees, preferably from 20 degrees to 30 degrees.

In this regard, it is advantageous if the opening has a diameter having a ratio in the range from 1:3 to 1:2 to the diameter of the outlet opening of the ejection nozzle.

Furthermore, it can be advantageous if the filling device is configured as a gas handling unit that can preferably be used for a hydrogen supply system, having: at least one temperature detection unit that is preferably the above-described temperature detection device, at least one pressure detection unit, and a safety valve integrated into a pipe section, wherein the safety valve can be adjusted between an open position, in which hydrogen is able to flow through the pipe section, and a closed position, in which gas is not able to flow through the pipe section, characterized in that the temperature detection unit and the pressure detection unit are disposed in such a way that they are able to detect a temperature and a pressure of the hydrogen flowing through the pipe section in a state in which the hydrogen is present at the closed safety valve in a pressure-exerting manner, and the valve unit is further configured to conduct, on the basis of the detected temperature and pressure values, a tightness test of the pipe section, in particular of a gas pressure tank system connected to the pipe section, in particular in the closed state of the safety valve.

In this regard, an excess flow valve and/or throttle valve can be advantageously provided upstream of the safety valve in the flow direction S1, in particular in the outflow direction of the hydrogen from the storage tank in the direction towards a consumer.

Here, it is further preferred that the filling device comprises a communication device, in particular a wireless communication device using infrared, radio, Bluetooth, or WLAN (wireless local area network), which is configured to communicate with the electrical loads, in particular control units of the electrical loads, or users of a charging station, in particular in order to start and/or control and/or regulate a refueling or charging process. The communication device and/or control device can thereby be configured such that, by means thereof, user identification or payment is performed before the refueling or charging process takes place.

Furthermore, it can be advantageous here that the communication device is configured to communicate with the control device, in particular to communicate with it in order to start and/or control and/or regulate a refueling process.

Furthermore, the present invention relates to a storage tank, in particular a hydrogen high-pressure storage tank, having a hollow body formed of a multi-layer laminate, a connecting piece inserted into the hollow body, and the above-described filling device, wherein the filling device can preferably be inserted or screwed into the connecting piece.

Moreover, the present invention relates to a method for filling a hydrogen tank with compressed gaseous hydrogen tank, having the steps of:
introducing the compressed hydrogen into a storage tank via a main body and a tube into the storage tank, and
creating a suction effect in at least one opening provided in the main body and/or in the tube by means of the Venturi effect by the flow of the hydrogen through the main body and/or the tube when the hydrogen flows into the storage tank.

### BRIEF DESCRIPTION OF THE FIGURES

Further features and advantages of a device, a use and/or a method are set out in the following description of embodiments with reference to the accompanying figures. In these figures:

FIG. 1 schematically shows the structure of a known filling device for hydrogen tanks (injector) according to the prior art,

FIG. 2 schematically shows the change in temperature distribution inside a storage tank during the filling process,

FIG. 3 schematically shows the speed profile of the hydrogen flowing into the storage tank during filling,

FIG. 4 schematically shows the structure of a filling device for hydrogen according to an embodiment of the present invention,

FIG. 5 schematically shows the structure of a valve unit, in particular an on-tank valve, into which the filling device according to the invention can be integrated,

FIG. 6 shows a pipeline and instrument flow diagram of an embodiment of a valve unit according to the invention,

FIG. 7 schematically shows an embodiment of a gas pressure tank system according to the invention, and

FIG. 8 shows a pipeline and instrument flow diagram of a further embodiment of a valve unit according to the invention.

### DESCRIPTION OF EMBODIMENTS

Identical reference numbers used in different figures designate identical, corresponding or functionally similar elements.

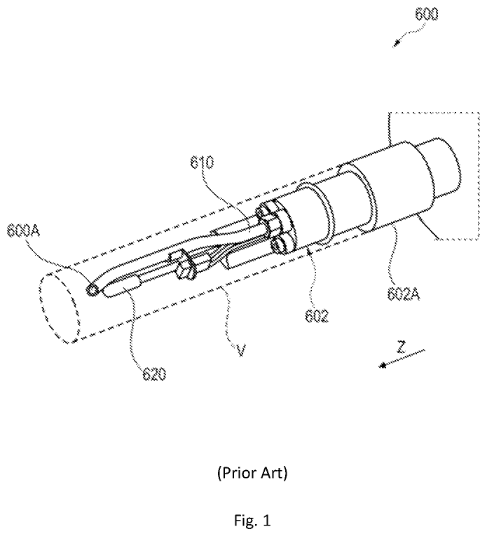

FIG. 1 schematically shows the structure of a known filling device 600 for hydrogen tanks (injector) according to the prior art. The illustrated filling device 600 is configured as a valve, in particular an on-tank valve, and comprises a valve main body 600 and a valve tube 602. The valve main body 600 is connected with an external gas supply pipe and can supply a fuel gas (hydrogen) stored in a storage tank to a consumer. When a fuel (hydrogen) is filled in, the valve main body 600 is connected with an external fuel supply system (e.g. hydrogen refueling station) and the fuel can be filled in. A mounting portion (for example, an external thread which is not shown) is formed on the outer circumferential surface of the valve tube 602. The valve can be mounted on a storage tank with the mounting portion. A tube 610 and a temperature sensor 620, which extend in the axial direction, are provided on the valve tube 602. The tube 610 has an opening 611 via which the hydrogen is fed into the storage tank. In this regard, the temperature sensor 620 serves to detect the prevailing temperature of the hydrogen introduced into the storage tank and, if necessary, i.e. if the detected temperature approaches an upper threshold value, to pause or to terminate the refueling process.

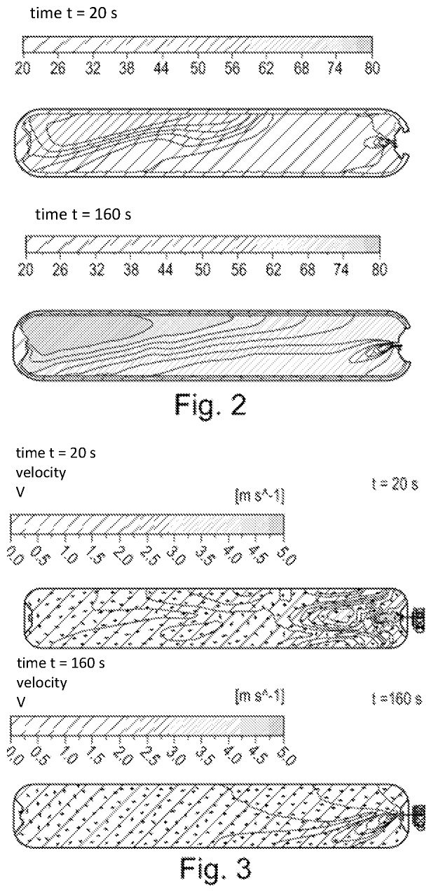

FIG. 2 schematically shows the change in temperature distribution inside a storage tank during the filling process with a conventional filling device. In this regard, the upper drawing in FIG. 2 shows the temperature distribution of the hydrogen inside the storage tank after a refueling period of 20 seconds. As apparent from the upper drawing, a temperature gradient is already starting to form from the top left corner to the inlet of the hydrogen on the right side of the storage tank. The temperature in the top left region of the storage tank already lies in a range of approximately 50° C., while temperatures of around 20° C. still prevail at the inlet of the hydrogen.

In the lower drawing of FIG. 2, 160 seconds of refueling have already passed, and the temperature gradient has developed correspondingly strongly in the meantime. At the left end of the storage tank, temperature peaks of up to 90° C. have formed, while the temperature on the liner on the side of the inlet is still around 65° C. In this regard, it is very clearly illustrated by FIG. 2 that despite the oblique inflow of hydrogen into the storage tank, the formation of a temperature gradient inside the storage tank cannot be avoided.

FIG. 3 schematically shows the speed profile of the hydrogen flowing into the storage tank during filling with a conventional filling device. It is apparent from both drawings that, as the refueling progresses and the pressure of the stored hydrogen increases, the flow behavior of the hydrogen inside the storage tank changes, in particular, when the pressure increases, the kinetic energy of the inflowing hydrogen is converted into thermal energy faster and faster, causing the inflowing hydrogen to heat up more quickly.

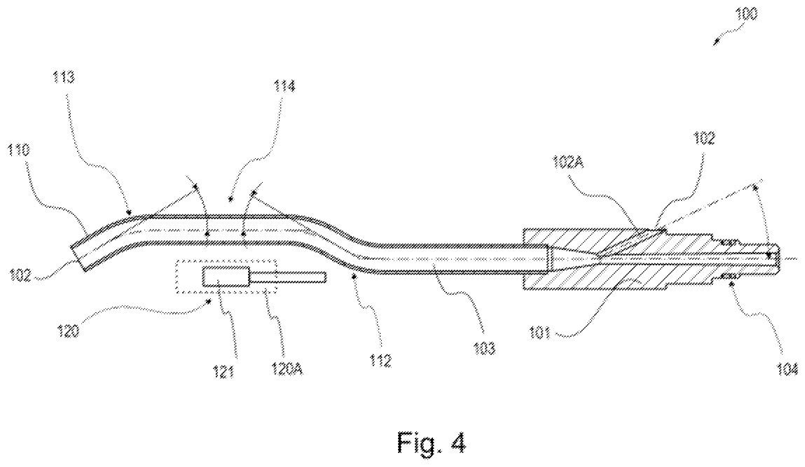

FIG. 4 schematically shows the structure of a filling device 100 for hydrogen according to a first embodiment of the present invention. The illustrated filling device has a main body 101, which is part of a valve body, and a tube 110 which is configured, in a state when inserted into a storage tank 300, to extend in an axial direction of the storage tank and to introduce hydrogen into the storage tank. Conventional storage tanks 300, in particular for vehicles, have an elongated cylinder shape, wherein the on-tank valve that preferably contains the filling device is provided at an end face of the storage tank 300 in such a way that the tube 110 extends along the longitudinal extension of the storage tank 300.

As further apparent from FIG. 4, the filling device 100, in particular the tube 110, has an ejection nozzle 11 which is provided at the end of the tube 110 that protrudes into the storage tank 300 and which serves to eject the hydrogen into the storage tank 300. Furthermore, the filling device has an opening 102 which is introduced into the main body 101 and/or the tube 110 and is configured to cause a suction effect or negative pressure on the hydrogen already present in the storage tank 300 when the hydrogen flows into the storage tank 300, whereby a circulating flow is formed in the storage tank. FIG. 4 also shows that the opening 102 is connected with a flow channel 103 in a flow-conducting manner in order to exert a Venturi effect on the opening 102 when the hydrogen flows through the tube 110 into the storage tank 300, whereby a part of the hydrogen present in the storage tank 300 is sucked into the opening 102 and mixed with the inflowing hydrogen. In this regard, it can also be advantageous to provide a plurality of openings 102 around the circumference of the main body 101 and/or the circumference of the tube 110, in particular so as to be distributed symmetrically around the circumference.

In this way, the hydrogen inside the storage tank is mixed more homogeneously, and the formation of a temperature gradient can thus be prevented.

In the illustrated embodiment, the opening 102 extends or is aligned in the axial direction (longitudinal direction) of the storage tank in a direction opposite to the ejection nozzle 111, in particular an opening direction of the ejection nozzle. In other words, the opening 102 extends preferably towards the head surface or end face of the storage tank 300, in which the connecting piece is provided.

As further apparent from the figure, the filling device 100 can have a temperature detection device 120 which extends from the main body 101 in the axial direction of the storage tank 300 towards the inside of the storage tank 300, wherein a temperature measuring portion 120A of the temperature detection device 120 is located between the ejection nozzle 111 and the main body 101.

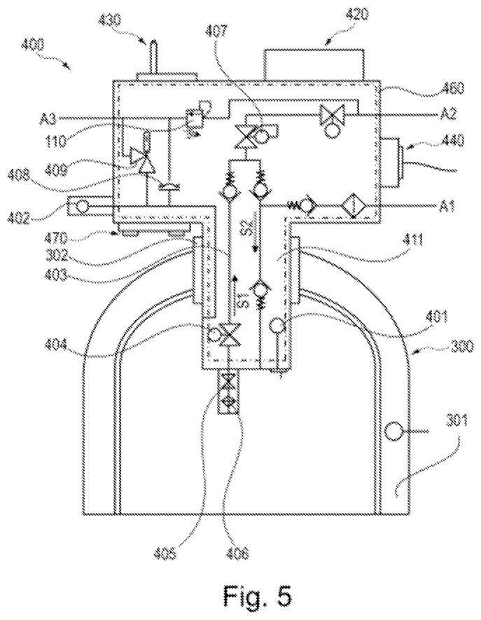

FIG. 5 schematically shows the structure of a valve unit 400, in particular an on-tank valve, into which the filling device according to the invention can be integrated. The illustrated valve unit 400 is configured as on-tank valve (OTV), in particular as OTV-R, i.e. an on-tank valve having a pressure regulating valve 407. As apparent from FIG. 5, the on-tank valve has a temperature detection unit 401 and a pressure detection unit 402. The temperature detection unit 401 is directly provided on a connecting piece 411 of the on-tank valve, by means of which the on-tank valve is attached to, in particular screwed into, the gas pressure tank 300. The temperature detection unit 401 is provided at the end of the connecting piece 411 that protrudes into the gas pressure tank 300. Accordingly, the temperature detection unit 401 is in direct contact with the fuel stored in the gas pressure tank 300.

The pressure detection unit 402, on the other hand, is accommodated in an external component which is connected to, in particular screwed to, the on-tank valve 400 in a gas-tight manner. The pressure detection unit 402 is in contact with the stored fuel (fuel gas or hydrogen) via an independent fluid pipe which extends at least in part through the connecting piece 411. Accordingly, the pressure detection unit 402 is able to directly detect or measure the pressure prevailing in the gas pressure tank or storage tank 300 (gas pressure tank pressure P1).

The illustrated on-tank valve 400 further has a safety valve 404 integrated into a pipe section 403, wherein the safety valve 404, which is preferably pulse-controlled, can be adjusted between an open position, in which gas is able to flow through the pipe section 403, and a closed position, in which gas is not able to flow through the pipe section 403. In the embodiment shown, the pipe section 403 serves to provide the fuel stored under high pressure (up to 900 bar) in the gas pressure tank 300 via a supply port A2 to a downstream consumer (not shown).

As apparent from FIG. 5, the temperature detection unit 401 and the pressure detection unit 402 are disposed in such a way that they are able to detect a temperature and a pressure of the gas flowing through the pipe section 403 in a state in which the gas is present at the closed safety valve 404 in a pressure-exerting manner. In other words, the two detection units, which are configured as sensors, can directly detect the temperature and the pressure of the fuel confined in the gas pressure tank by the safety valve 404.

If the safety valve 404 is opened, the fuel stored in the gas pressure tank or storage tank 300 under high pressure, about 350 bar, 700 bar, 875 bar or 900 bar, flows via the pipe section 403 in the direction towards the supply port A2, whereby the stored fuel is provided to a downstream consumer. Before it reaches the safety valve 404, the stored fuel first flows through a filter 406 in order to remove contaminants present in the stored fuel. The fuel subsequently flows through an excess flow valve 405, whereby the maximum flow of the fuel flowing out of the gas pressure tank 300 is limited, in particular is limited such that the maximum flow is determined so as to be slightly higher than the maximum flow required by the connected consumer.

In this manner, on the one hand a sufficiently great fuel flow for supplying the downstream consumer or the downstream consumers is ensured, on the other hand the flow is limited as far as possible so that an undesirably large amount of fuel does not escape in the event of a fault.

Downstream of the safety valve 404 in the flow direction S1, the pressure regulating valve 407 is provided in the pipe section 403, which reduces and/or regulates the gas pressure introduced by the gas pressure tank 300 (gas pressure tank pressure P1) to an operating pressure P2 which is preset or adapted to the operating load of the downstream consumer.

Between the safety valve 404 and the pressure regulating valve 407, a check valve is disposed such that a return flow from the pressure regulating valve 407 in the direction towards the safety valve 404 is prevented.

Furthermore, in the illustrated embodiment, a further, preferably magnetic, safety valve is disposed downstream of the pressure regulating valve 407, wherein it is possible by means of this safety valve to block or confine the fuel already reduced to the operating pressure P2 in the valve unit 400, in particular the on-tank valve, and to empty the consumer, for example a fuel cell system, disposed downstream thereof. In other words, to remove the fuel from the fuel cell system and thus reduce the pressure that is present. It is further advantageous if the further safety valve is configured such that it is able to open only up to a predetermined pressure, such as, for example, 50 bar, that is to say a pressure which on the one hand is lower than the maximum pressure of 350 bar, 700 bar, 875 bar or 900 bar prevailing in the gas pressure tank 300 and on the other hand is greater than the operating pressure P2 required by the downstream consumer.

The illustrated on-tank valve 400 further has a first excess pressure device 410 in the form of an excess pressure valve, which in the embodiment shown is set to a pressure of 19 bar, thus the operating pressure P2 present at the downstream consumer is limited to 19 bar. If the pressure regulating valve 407 has a fault and reduces, for example, the pressure of the fuel only to 50 bar, the excess pressure valve 410 opens and discharges the excess fuel to the environment via the discharge port A3.

As further apparent from FIG. 5, the illustrated on-tank valve 400 further has a second excess pressure device 408 which is configured as a rupture disk and is adapted to protect the gas pressure tank 300 connected to the on-tank valve 400 from excess pressure.

The on-tank valve 400 further has a thermal pressure relief device 409 which is configured to open at a predetermined temperature threshold value, i.e. to open a valve of the pressure relief device 409 that is closed by default, in order to release the fuel stored in the gas pressure tank 300 to the environment via the discharge port A3. The pressure relief device 409 is configured such that the fuel cannot escape too quickly, in order to protect the gas pressure tank 300 from damage, but nevertheless to allow the fuel to escape at a sufficiently high speed, generally within from 3 to 5 minutes, so that the integrity of the gas pressure tank 300 can be ensured until it is completely empty.

The pressure relief device 409 can be disposed, as shown in the illustrated embodiment, parallel to the second excess pressure device 408 (rupture disk) and the pressure detection unit 402 in a fluid line which connects the discharge port A3 to the interior (storage chamber) of the gas pressure tank 300 so as to carry fluid. The pressure relief device 409 can further be irreversibly actuated, i.e. opened, by rupturing of a glass body, wherein the rupturing of the glass body is set in such a way that rupturing occurs at a predetermined temperature and optionally only after the predetermined temperature has been present for a specified time period. It is advantageous for safety reasons if the actuation or triggering of the pressure relief device takes place irreversibly, in order that undesirable closing can be ruled out after the pressure relief device has been actuated or triggered once. Actuation of the pressure relief device can, however, also take place by an external pulse or by activation.

As is further shown in FIG. 5, the illustrated on-tank valve has a control device 420 which can serve to evaluate and optionally to log the values detected by the detection units 401 and 402 and to determine a state of integrity of the gas pressure tank 300 and of the on-tank valve 400 on the basis of the detected values. The control device 420 is further configured to control a fuel supply operation of the downstream consumer, in particular to correspondingly open or close the pressure regulating valve 407, on the basis of the detected values. In order to be able to set different pressures, the pressure regulating valve can also be partially opened or closed, so that degrees of opening of between 0% and 100% are also possible.

The on-tank valve 400 illustrated in FIG. 5 further has a communication device which has, for example, a Bluetooth and a WLAN antenna, by means of which the on-tank valve 400 can communicate wirelessly with external clients. The shown on-tank valve further has a leakage detection unit as already described in detail above.

Finally, the shown on-tank valve 400 has a refueling port (filling port) A1, by means of which the gas pressure tank can be filled with gas, in particular fuel. For this purpose, the illustrated on-tank valve 400 has a separate refueling channel in which the introduced fuel is guided in the flow direction S2 into the gas pressure tank 300. In the refueling channel, a filter is in turn provided in order to prevent contaminants present in the fuel to be introduced from entering the gas pressure tank 300 and accumulating therein. Downstream of the filter in the flow direction S2, there is further disposed a check valve or a plurality of check valves connected one after the other, which prevent(s) the introduced fuel from flowing back to the filter. A further check valve is further provided at the end of the refueling channel facing the gas pressure tank 300, which prevents the introduced fuel from escaping via the refueling port A1.

After the shown check valve, the filling device according to the invention, as illustrated in FIG. 4, can be provided in order to set the hydrogen introduced into the storage tank 300 into a circulating motion during refueling or filling so as to prevent possible temperature gradients in the hydrogen stored in the storage tank 300.

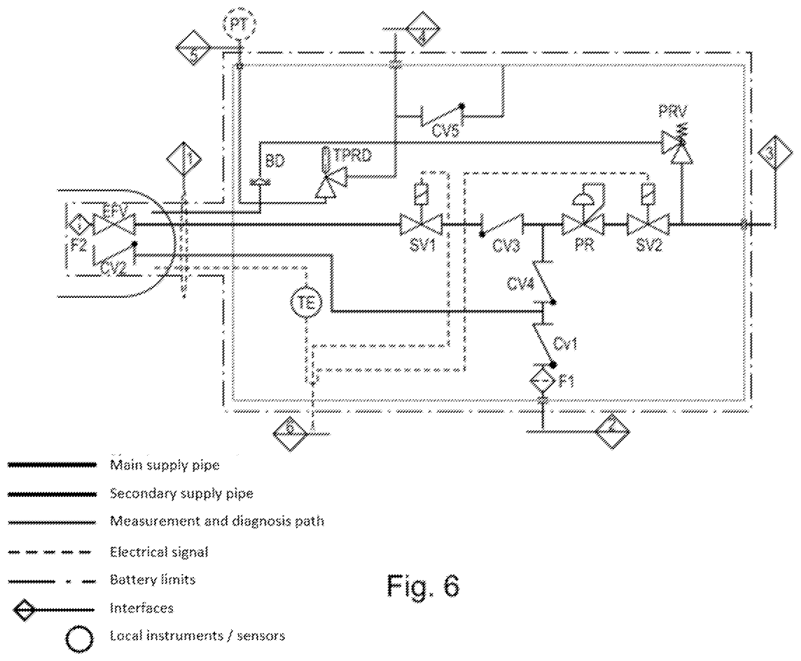

FIG. 6 shows a pipeline and instrument flow diagram of an embodiment of a valve unit 400 according to the invention, wherein the illustrated valve unit corresponds in terms of its essential structure to the on-tank valve 400 illustrated in FIG. 3.

As apparent from FIG. 6, the shown valve unit 400, in particular gas handling unit, has six interfaces with which the valve unit 400 can be connected with external components, in particular can be connected so as to carry fluid. The interface 1, for example, serves to connect a single gas pressure tank 300 or a gas pressure tank system to the valve unit 100. Accordingly, the interface 1 has a feeding pipe (secondary supply pipe) via which the gas pressure tank 300 can be filled with fuel, a main supply pipe via which the fuel stored under high pressure in the gas pressure tank 300 can be fed to a consumer, and two measurement and diagnosis paths. The first measurement and diagnosis path connects the interior (fuel filling) of the gas pressure tank 300 with a temperature element (temperature detection unit 401) which is provided in the valve unit and by means of which the temperature of the fuel in the gas pressure tank 300 can be detected. The second measurement and diagnosis path is divided between three paths/pipes arranged in parallel, on one of the three paths there is formed on the one hand an interface 5 with which an exchangeable/mountable pressure sensor element (pressure detection unit 402) is connected. The pressure sensor element connected with the interface 5 detects the pressure inside the gas pressure tank 300 via the second measurement and diagnosis path. In a second path, a rupture disk (excess pressure device 408) is disposed which protects the connected gas pressure tank 300 from excess pressure. In other words, if, for example during filling of the gas pressure tank, the pressure inside the gas pressure tank 300 reaches a predetermined threshold value, for example 900 bar, as a result of a faulty refueling system, the rupture disk breaks and thereby opens the access to the interface 4 (discharge port A3), via which the fuel can be discharged to the ambient air.

At the third path, a thermal pressure relief device (TPRD) is provided which, when a predetermined threshold value/maximum temperature is reached, for example in the event of an accident resulting in a fire, also opens an access to the interface 4 (discharge port A3), whereby the fuel stored in the gas pressure tank 300 can be discharged/released to the environment in a controlled manner. A channeled release to the environment can take place. This is to be understood as meaning that the direction of release is chosen such that the outflowing fuel is released in a direction in which no components and/or persons are endangered.

As further apparent from FIG. 6, inside the gas pressure tank 300, a filter F2, a check valve CV2 and an excess flow valve EFV are disposed, the function of which has already been described in connection with FIG. 3.

In the main supply pipe, in the flow direction to an interface 3 with which a downstream consumer such as, for example, a fuel cell system can be connected, a safety valve SV1, a check valve CV3, a pressure regulating valve PR and a further safety valve SV2 are disposed, wherein the two safety valves are configured as solenoid valves.

Furthermore, an excess pressure device PRV is connected in the flow direction downstream of the second safety valve SV2, which triggers when a preset maximum pressure is reached that is chosen in such a way that the downstream consumer cannot be damaged and which, in the actuated state, opens an access to the interface 4 (discharge port A3), whereby the excess fuel can be released to the outside.

Additionally, the shown valve unit 400 has an interface 2 via which, for example, a refueling system can be connected with the valve unit 400 for filling the gas pressure tank 300. A filter F1, a check valve CV1 and the check valve CV2 provided in the gas pressure tank 300 are disposed in the flow direction from the interface 2 to the interface 1, with which the gas pressure tank 300 is connected. The feeding pipe (secondary supply pipe) is advantageously connected via a check valve CV4 with the main supply pipe, in particular between the check valve CV3 and the pressure regulating valve PR.

Interface 6 illustrates a signal connection by means of which the safety valves SV1 and SV2, the pressure regulating valve PR and the sensor elements PT, TE can be connected with a control unit, wherein the control unit can be integrated into the valve unit 400.

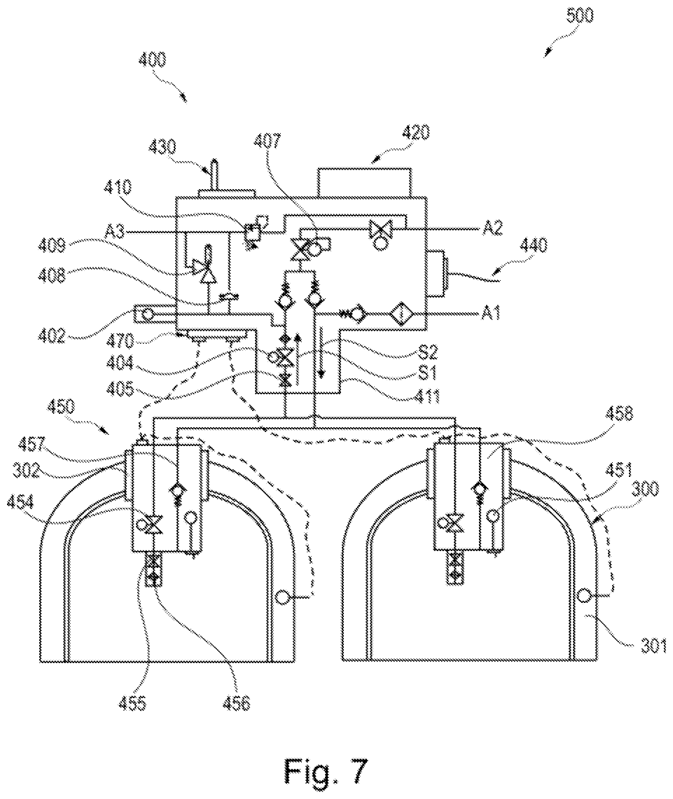

FIG. 7 schematically shows an embodiment of a gas pressure tank system 500 according to the invention, which consists by way of example of two gas pressure tanks 300, two on-tank valves 450, each of which is screwed into a gas pressure tank 300, and a valve unit 400 configured as a gas handling unit. The gas handling unit comprises all the components or associated functions described in relation to the on-tank valve 400 shown in FIG. 5.

The two illustrated on-tank valves 450, on the other hand, are limited to minimally necessary safety functions. For example, the two on-tank valves 450 each have a safety valve 454 by means of which an undesired outflow of the fuel from the individual gas pressure tanks 300 can be prevented, in particular in the event of an accident. Accordingly, the protection valves 454, like the protection valve 404 of the gas handling unit 400, are self-closing valves. Moreover, the on-tank valves 450 each comprise an excess flow valve 456 which is configured to limit the outflow of the fuel to a predetermined maximum value. The on-tank valves 450 further have a refueling channel 457 which is provided with a check valve. Furthermore, a filter 455 is disposed upstream of the safety valve 454, in particular upstream of the excess flow valve 456. Finally, the two on-tank valves 450 also have a temperature and/or pressure detection unit 451.

The gas handling unit 400 disposed downstream of the on-tank valves 450 in the outflow direction S1 also has an excess flow valve 406 which serves to limit the fuel flow amount accumulated by the plurality of connected gas pressure tanks 300 (here two). Moreover, the gas handling unit 400 has a connection portion 430 by means of which the two on-tank valves 450 are electrically and electronically connected with the gas handling unit 400, in particular the control unit 420 thereof. In this manner, the control unit 420 can access the values or data determined by means of the temperature and/or pressure detection unit 451 and, if necessary, actuate the safety valves 454 accordingly.

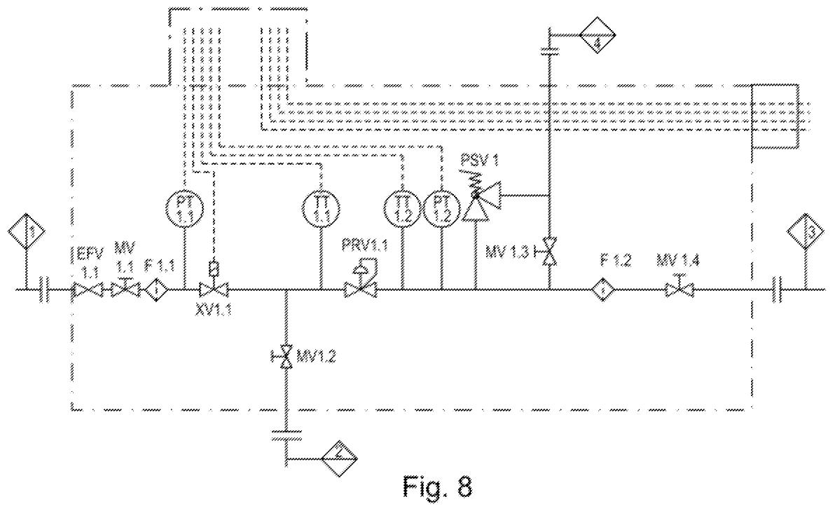

FIG. 8 shows a pipeline and instrument flow diagram of a further embodiment of a valve unit 400 according to the invention, wherein the shown valve unit is a further development of the valve unit shown in FIGS. 3 to 5. The valve unit shown in FIG. 8 also has the interfaces 1 to 4, only the interfaces 5 (pressure detection unit 102) and 6 (signal connection) are absent.

This is due to the fact that the control device 420 and the pressure detection unit 402 are integrated directly into the valve unit 400.

As further apparent from FIG. 8, in the illustrated embodiment of the valve unit 400, in the flow direction from the interface 1 to the interface 3, with which a consumer can also be connected, there are in the main supply pipe an excess flow valve EFV1.1, a first manual valve (safety valve) MV1.1, a filter F1.1, a solenoid valve XV 1.1, a pressure regulating valve PRV1.1, a second filter F1.2 and a second manual valve MV1.4. Just as in FIG. 6, an excess pressure device PSV1 is also provided here downstream of the pressure regulating valve PRV1.1 which can release excess fuel to the outside via the interface 4.

The major difference to the valve unit described in FIG. 6 is on the one hand that not only are a pressure sensor PT1.1 and a temperature sensor TT1.1 provided upstream of the pressure regulating valve PRV1.1, but a pressure sensor PT1.2 and a temperature sensor TT1.2 are also provided downstream of the pressure regulating valve PRV1.1 in the flow direction. This configuration is advantageous in particular if the valve unit 400 has a temperature-control device 470. In this case, the state (temperature and pressure) of the fuel after pressure reduction has been carried out by the pressure regulating valve PRV1.1 can be detected by means of the second sensor pair PT1.2, TT1.2, and the temperature-control device 470 can be controlled accordingly. In this manner, it is possible to optimally condition the fuel for the downstream consumer. Furthermore, the state information additionally determined can be used for conducting the tightness test. In this manner, the tightness test, in particular the tightness test of the gas pressure tank 300 and/or of the gas pressure tank system 500, can be conducted more reliably in particular during operation of the downstream consumer, in particular of the fuel cell system, that is to say while the fuel stored in the gas pressure tank 300 is continuously flowing out.

### LIST OF REFERENCE NUMBERS

100 Filling device
101 Main body
102 Opening
102A Flow channel
103 Flow channel
104 Connecting piece
110 Tube
111 Ejection nozzle
112 First curved section
113 Second curved section
114 Connecting section
120 Temperature detection device
120A Temperature measuring portion
121 Temperature sensor
300 Storage tank
301 Hollow body
302 Connecting piece
400 Gas handling unit
401 Temperature detection unit
402 Pressure detection unit
403 Pipe section
404 Safety valve
405 Excess flow va

1. A filling device for filling a storage tank with compressed hydrogen, the filling device comprising:
a main body;
a tube which is configured, in a state when inserted into a storage tank, to extend and to introduce hydrogen into the storage tank;
an ejection nozzle which is provided at one end of the tube, and which serves to eject the hydrogen into the storage tank; and
at least one opening which is introduced into the main body, the tube, or a combination thereof, and is configured to cause a suction effect or negative pressure on the hydrogen already present in the storage tank when the hydrogen flows into the storage tank.

2. The filling device according to claim 1, wherein the opening is connected with a flow channel in a flow-conducting manner in order to exert a Venturi effect on the opening when the hydrogen flows through the tube into the storage tank.

3. The filling device according to claim 1, wherein the opening is configured such that a circulation of the hydrogen introduced into the storage tank can be generated from the ejection nozzle to the opening, wherein the opening extends or is aligned in a direction opposite to the ejection nozzle.

4. The filling device according to claim 1, wherein the filling device is configured as an injector.

5. The filling device according to claim 4, further comprising a connecting piece configured in such a way that it can be inserted or screwed into the storage tank.

6. The filling device according to claim 1, wherein the tube comprises:
a first curved section located between the ejection nozzle and the main body and extending in a direction that is inclined relative to the axial direction of the storage tank; and
a second curved section extending in a direction that is inclined relative to the axial direction of the storage tank.

7. The filling device according to claim 6, wherein one of an inclination angle of the first curved section relative to the axial direction of the storage tank and an inclination angle of the second curved section relative to the axial direction is greater than 0 degrees and not greater than 90 degrees, and the other one is not smaller than −90 degrees and smaller than 0 degrees when the tube is viewed in a direction perpendicular to the axial direction of the storage tank.

8. The filling device according to claim 6, wherein a connecting section is provided between the first curved section and the second curved section, so that the tube extends in the axial direction towards the inside of the storage tank.

9. The filling device according to claim 1, further comprising a temperature detection device which extends from the main body in the axial direction of the storage tank towards the inside of the storage tank, wherein a temperature measuring portion of the temperature detection device is located between the ejection nozzle and the main body.

10. The filling device according to claim 1, wherein a flow channel formed by the opening, which connects the opening with the flow channel formed in the tube and/or the main body in a flow-conducting manner, forms an inclination angle relative to the axial direction of the storage tank in a range from 15 degrees to 45 degrees.

11. The filling device according to claim 1, wherein the opening has a diameter having a ratio in the range from 1:3 to 1:2 to the diameter of an outlet opening of the ejection nozzle.

12. The filling device according to claim 1, wherein the filling device is configured as a gas handling unit comprising:
at least one temperature detection unit;
at least one pressure detection unit; and
a safety valve integrated into a pipe section, wherein the safety valve can be adjusted between an open position, in which hydrogen is able to flow through the pipe section, and a closed position, in which gas is not able to flow through the pipe section,
characterized in that
the temperature detection unit (401) and the pressure detection unit are disposed in such a way that they are able to detect a temperature and a pressure of the hydrogen flowing through the pipe section in a state in which the hydrogen is present at the closed safety valve in a pressure-exerting manner, and
the gas handling unit is further configured to conduct, on the basis of the detected temperature and pressure values, a tightness test of the pipe section.

13. The filling device according to claim 12, wherein an excess flow valve, a throttle valve, or both, is provided upstream of the safety valve in an flow direction (S1) of the hydrogen from the storage tank in the direction towards a consumer.

14. A storage tank, comprising:
a hollow body formed of a multi-layer laminate;
a connecting piece inserted into the hollow body; and
the filling device of claim 1.

15. A method for filling a hydrogen tank with compressed hydrogen, the method comprising:
introducing the compressed hydrogen into a storage tank via a main body and a tube into the storage tank; and
creating a suction effect in at least one opening provided in the main body, in the tube, or in a combination thereof, by Venturi effect by the flow of the hydrogen through the main body, the tube, or the combination thereof, when the hydrogen flows into the storage tank.

16. The method according to claim 15, wherein a compressed hydrogen already present or stored in the hydrogen tank is set into a circulating motion or flow by the created suction effect in the opening.

17. The method according to claim 15, wherein the suction effect in the opening is provided in a filling device comprising:
a main body;
a tube which is configured, in a state when inserted into the storage tank, to extend and to introduce hydrogen into the storage tank;
an ejection nozzle which is provided at one end of the tube, and which serves to eject the hydrogen into the storage tank; and
at least one opening which is introduced into the main body, the tube, or a combination thereof, and is configured to cause a suction effect or negative pressure on the hydrogen already present in the storage tank when the hydrogen flows into the storage tank.
